(19) United States
(12) Patent Application Publication
(10) Pub. No.: US 2019/0389698 A1
(43) Pub. Date: Dec. 26, 2019

(54) ELEVATOR CAR WITH A MOVABLE WORKING PLATFORM

(71) Applicant: Otis Elevator Company, Farmington, CT (US)

(72) Inventors: Agustin Jimenez-Gonzalez, Alcorcon (ES); Juan Quiles, Rivasvaciamadrid (ES)

(21) Appl. No.: 16/440,476

(22) Filed: Jun. 13, 2019

(30) Foreign Application Priority Data
Jun. 25, 2018 (EP) 18179543.6

(51) Int. Cl. B66B 11/02

(52) U.S. Cl. CPC B66B 11/0246

(57) ABSTRACT

An elevator car (6) defining an interior space (12) for accommodating passengers and/or cargo comprises a support frame (22) positioned on top of the interior space (12); and a working platform (28) movably mounted to the support frame (22) by a support structure (31). The support structure (31) comprises at least one scissor mechanism (30) including two scissor legs (30a, 30b) pivotably connected with each other. A first end of each scissor leg (30a, 30b) is pivotably connected to the support frame (22), and a second end of each scissor leg (30a, 30b) is pivotably connected to the working platform (28). The support structure (31) further comprises at least one gas spring element (32) extending between the scissor legs (30a, 30b) of the at least one scissor mechanism (30). The at least one gas spring element (32) may be configured for supporting the movement of the working platform (28).

### FOREIGN PRIORITY

This application claims priority to European Patent Application No. 18179543.6, filed Jun. 25, 2018, and all the benefits accruing therefrom under 35 U.S.C. § 119, the contents of which in its entirety are herein incorporated by reference.

### BACKGROUND

The invention relates to an elevator car with a movable working platform, and to an elevator system comprising such an elevator car.

An elevator system comprises at least one elevator car traveling along a hoistway between a plurality of landings. For repair and/or maintenance purposes, it may be necessary for a mechanic to access an area on top or above the elevator car.

It is desirable to provide an elevator car allowing a mechanic to access an area on top or above the elevator car safely and conveniently.

### BRIEF DESCRIPTION

Exemplary embodiments of the invention include an elevator car comprising an interior space for accommodating passengers and/or cargo. The elevator car has a support frame positioned on top of the interior space, a working platform, and a support structure movably connecting the working platform with the support frame. The support structure comprises at least one scissor mechanism including two scissor legs pivotably connected with each other. A first end of each scissor leg is pivotably connected to the support frame, and a second end of each scissor leg is pivotably connected to the working platform. The support structure further comprises at least one gas spring element extending between the scissor legs of the at least one scissor mechanism. The at least one gas spring element in particular is configured for supporting the movement of the working platform.

Exemplary embodiments of the invention further include an elevator system comprising at least one elevator car according to an exemplary embodiment of the invention.

According to exemplary embodiments of the invention, the working platform is movable between a retracted storage position and a deployed working position.

When arranged in the retracted storage position, the working platform and the support structure are arranged in a folded configuration at the top of the elevator car within or close to the support frame so that it does not occupy a substantial amount of space within the interior space of the elevator car.

When arranged in the deployed working position, the working platform and the support mechanism are arranged in an unfolded configuration. In the deployed working position, the working platform is lowered from the top of the elevator car into the interior space allowing a mechanic to step onto the working platform for performing repair and/or maintenance work, in particular in an area on top or above the elevator car.

Exemplary embodiments of the invention also include moving the working platform from the retracted storage position into the deployed working position and vice versa.

The at least one gas spring element extending between the scissor legs of the at least one scissor mechanism in particular supports the movement of the working platform between the retracted storage position and the deployed working position.

The at least one gas spring element in particular bears some of the weight of the working platform slowing down the movement of the working platform from the retracted storage position into the deployed working position. In other words, the at least one gas spring element in particular prevents the working platform from dropping from the retracted storage position into the deployed working position. In consequence, the risk of injury for a mechanic moving the working platform is considerably reduced.

In addition, bearing some of the weight of the working platform by the at least one gas spring element makes it easier and more convenient for the mechanic to raise the working platform from the deployed working position into the retracted storage position.

As a result, the handling of the working platform is improved, and a safe and convenient access to areas on top of and/or above the elevator car is provided.

A number of further optional features are set out in the following. These features may be realized in particular embodiments, alone or in combination with any of the other features.

The working platform and/or the support frame may have a polygonal shape, in particular a rectangular shape, comprising a plurality of corners. Each of the scissor legs may be connected to a corner of the working platform and/or to a corner of the support frame, respectively. Such a configuration allows the scissor mechanism to efficiently and safely support the working platform.

Each scissor leg has a middle portion between its first and second ends. The two scissor legs of the at least one scissor mechanism may be pivotably connected to each other by a central joint located at the respective middle portions. As a result, the two legs form an effective scissor mechanism.

The length of each of the scissor legs may be variable. The scissor legs in particular may be telescopic scissor legs. Scissor legs having a variable length allow moving the working platform between the deployed working position and the retracted storage position without moving the ends of the legs linearly along the support frame and/or along the working platform, respectively. This simplifies the design of the scissor mechanisms and eliminates the risk of injury caused by scissor legs moving linearly along the support frame and/or along the working platform, respectively.

The at least one gas spring element may extend basically horizontally between the scissor legs. The at least one gas spring element may extend between the scissor legs above and/or below the central joint.

In an alternative configuration, the at least one gas spring element may extend basically vertically between the scissor legs on the left and/or right side of the central joint.

Each scissor mechanism may comprise two or more gas spring elements extending basically horizontally and/or vertically.

The support structure may comprise two scissor mechanisms attached to opposite sides of the working platform. Such a configuration results in a symmetric and very stable support of the working platform.

When two or more scissor mechanisms are provided, each scissor mechanism may comprise at least one gas spring element, respectively. Providing a plurality of gas spring elements increases the effect provided by the gas spring elements facilitating the movement of the working platform even further.

The elevator car may further comprise at least one stabilizer mechanism extending between the support frame and the working platform. The at least one stabilizer mechanism may be configured for mechanically stabilizing the working platform, in particular when it is arranged in the deployed working position in order to increase the safety of a mechanic working on the working platform.

For forming an efficient stabilizer mechanism, the at least one stabilizer mechanism may comprise a first stabilizer leg and a second stabilizer leg pivotably connected with each other. A first end of the first stabilizer leg may be pivotably mounted to the support frame, and a first end of the second stabilizer leg may be pivotably mounted to the working platform. The second ends of the first and second stabilizer leg may be pivotably connected with each other.

For increasing the stability of the working platform even further, the elevator car may comprise a plurality of stabilizer mechanisms. Each stabilizer mechanism may extend between a corner of a polygonal working platform and a corresponding position at the support frame, respectively. In particular, a stabilizer mechanism may be mounted to each corner of the polygonal working platform.

The polygonal working platform in particular may be a rectangular working platform with four corners, and the elevator car may comprise four stabilizer mechanisms, wherein one stabilizer mechanism is mounted to each of the four corners of the working platform, respectively.

The working platform may extend over the whole area of the top area (ceiling) of the elevator car. Alternatively, the working platform may extend only over a fraction of the ceiling, i.e. the ceiling may comprise at least one further portion which is not part of the movable working platform. The at least one further portion of the ceiling may be stationary (non-movable), or it may comprise further movable parts, such as flaps, providing access to further portions on top and/or above the elevator car.

The elevator car may further comprise a cover element attached to the support frame. The cover element may be arrangeable in a covering position in which it is arranged between the working platform and the interior space covering the working platform, when the working platform is arranged in its retracted storage position. The pivotably mounted cover element may allow accessing the working platform by moving the cover element out of its covering position into an access position. The cover element may extend basically vertically when arranged in the access position.

The cover element in particular may be pivotably attached to the support frame.

The cover element may support or include at least one illumination element which is configured for illuminating the interior space of the elevator car. Arranging at least one illumination element at the cover element allows accessing the at least one illumination element easily by pivoting the cover element into its access position providing access to the rear side of the cover element. The illumination element may include an LED or an arrangement of a plurality of LEDs.

The cover element may provide a decorative ceiling of the interior space of the elevator car.

The support structure, the working platform and/or the cover element may be lockable in at least one of their retracted and deployed positions in order to prevent an unauthorized and/or undesired movement of the working platform. The support structure, the working platform and/or the cover element in particular may be provided with a lock. A key, which is available only to authorized personnel, may be necessary for unlocking the lock.

Moving the working platform from its retracted storing position into its deployed working position may include unlocking the support structure, the working platform and/or the cover element in order to allow moving the working platform between its retracted storage position and the deployed working position.

After the working platform has been moved back into its deployed working position, the support structure, the working platform and/or the cover element may be locked, in order to prevent an unauthorized movement of the working platform.

The working platform may comprise a storage space. The storage space may be configured for accommodating a ladder. The storage space may be formed on top of the working platform or in a lower portion of the working platform. Storing a ladder above or below the working platform allows a mechanic to climb onto the working platform more easily. There in particular is no need for the mechanic to bring his own ladder.

The ladder in particular may be a telescopic ladder. Employing a telescopic ladder allows a relatively long ladder, in particular a ladder bridging the distance between the floor of the elevator car and the working platform in its deployed working position, being stored in a comparatively small storage space, which is limited by the dimensions of the working platform.

### DRAWING DESCRIPTION

In the following an exemplary embodiment of the invention is described with reference to the enclosed figures.

FIG. 1 schematically depicts an elevator system comprising an elevator car according to an exemplary embodiment of the invention.

FIG. 2 shows a perspective view of a top portion (ceiling) of an elevator car according to an exemplary embodiment of the invention comprising a working platform arranged in its retracted storage position.

FIG. 3 shows a perspective view of the portion of the ceiling shown in FIG. 2, with the working platform still arranged in its retracted storage position and a cover element arranged in an access position allowing access to the working platform.

FIG. 4 shows a perspective view of the portion of the ceiling shown in FIGS. 2 and 3 with the working platform being arranged in an intermediate position.

FIG. 5 shows a perspective view of the portion of the ceiling shown in FIGS. 2 to 4 with the working platform arranged in the deployed working position.

### DETAILED DESCRIPTION

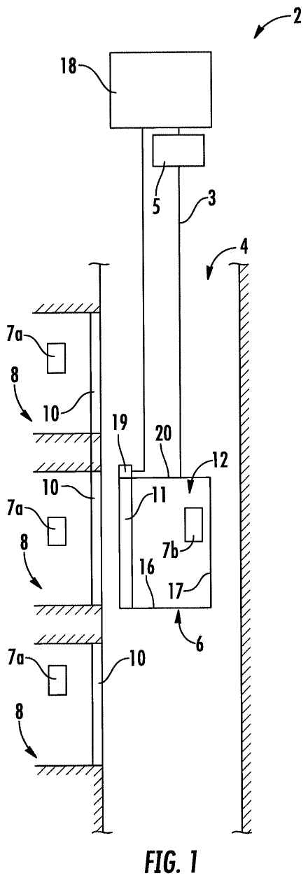

FIG. 1 schematically depicts an elevator system 2 comprising an elevator car 6 according to an exemplary embodiment of the invention.

The elevator system 2 comprises a hoistway 4 extending in a longitudinal direction between a plurality of landings 8 located on different floors.

The elevator car 6 comprises a floor 16, a ceiling 20 and sidewalls 17 extending between the floor 16 and the ceiling 20 defining an interior space 12 of the elevator car 6. Only one sidewall 17 is depicted in the schematic illustration of FIG. 1.

The elevator car 6 is movably suspended within the hoistway 4 by means of a tension member 3. The tension member 3, for example a rope or belt, is connected to a drive 5, which is configured for driving the tension member 3 in order to move the elevator car 6 along the longitudinal direction/height of the hoistway 4 between the plurality of landings 8.

Each landing 8 is provided with a landing door (elevator hoistway door) 10, and the elevator car 6 is provided with a corresponding elevator car door 11 allowing passengers to transfer between a landing 8 and the interior space 12 of the elevator car 6 when the elevator car 6 is positioned at the respective landing 8.

The exemplary embodiment of the elevator system 2 shown in FIG. 1 employs a 1:1 roping for suspending the elevator car 6. The skilled person, however, easily understands that the type of the roping is not essential for the invention and that different kinds of roping, e.g. a 2:1 roping, may be used as well.

The elevator system 2 may further include a counterweight (not shown) moving concurrently and in opposite direction with respect to the elevator car 6. Alternatively, the elevator system 2 may be an elevator system 2 without a counterweight, as it is shown in FIG. 1. The drive 5 may be any form of drive used in the art, e.g. a traction drive, a hydraulic drive or a linear drive. The elevator system 2 may have a machine room or may be a machine room-less elevator system. The elevator system 2 may use a tension member 3, as it is shown in FIG. 1, or it may be an elevator system without a tension member 3, comprising e.g. a hydraulic drive or a linear drive (not shown).

The drive 5 is controlled by an elevator control 18 for moving the elevator car 6 along the hoistway 4 between the different landings 8.

Input to the elevator control 18 may be provided via landing control panels 7a, which are provided on each landing 8 close to the elevator landing doors 10, and/or via a car operation panel 7b provided inside the elevator car 6.

The landing control panels 7a and the car operation panel 7b may be connected to the elevator control 18 by means of electrical lines, which are not shown in FIG. 1, in particular by an electric bus, e.g. a field bus such as a CAN bus, or by means of wireless data connections.

In order to determine the current position of the elevator car 6, the elevator car 6 is provided with a position sensor 19. The position sensor 19 may be arranged at the top of the elevator car 6 as shown in FIG. 1. Alternatively, the position sensor 19 may be provided at a side of the elevator car 6 or at the bottom, e.g. below a floor 16, of the elevator car 6.

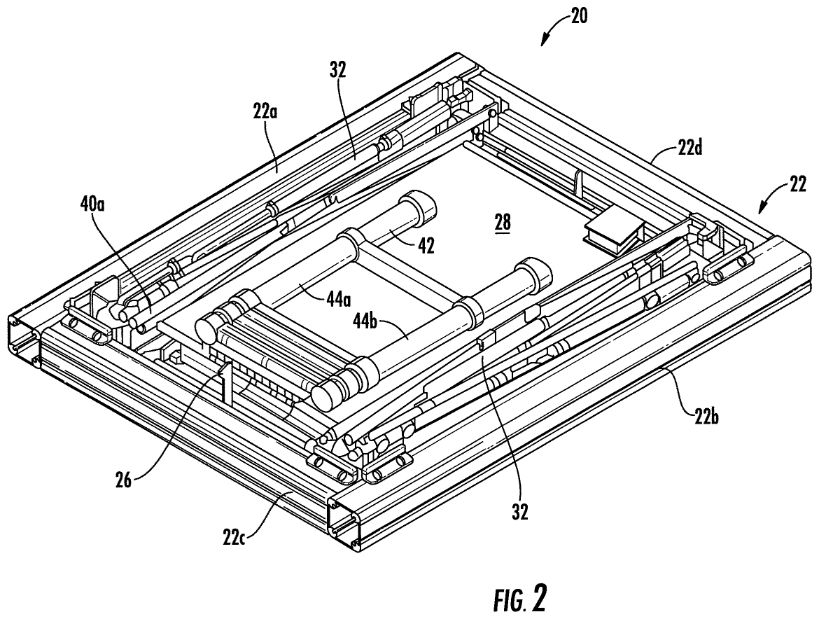

FIGS. 2 to 5 show perspective views of a portion of the ceiling 20 of an elevator car 6 according to an exemplary embodiment of the invention, respectively. In order to allow for an unobstructed view into the interior space 12 of the elevator car 6, the side walls 17 (cf. FIG. 1) of the elevator car 6 are not depicted in FIGS. 2 to 5.

FIG. 2 shows a perspective view of a portion of a ceiling 20 of an elevator car 6 according to an exemplary embodiment of the invention with the working platform 28 arranged in its retracted storage position.

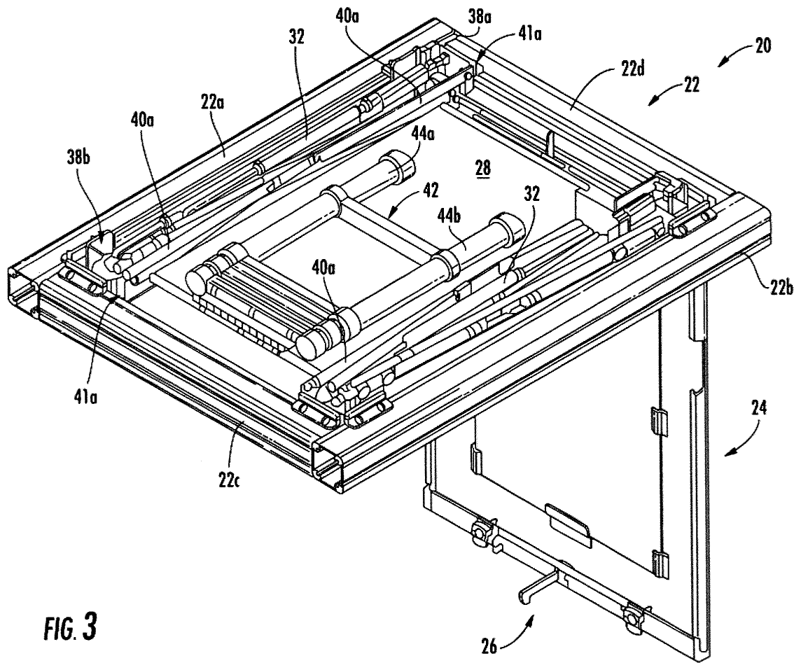

FIG. 3 shows a perspective view of the portion of the ceiling 20 shown in FIG. 2, with the working platform 28 still arranged in its retracted storage position. FIG. 3 further depicts a cover element 24 arranged in an access position allowing access to the working platform 28. In FIG. 2 the cover element 24 is arranged in its covering position parallel to the working platform 28. In this configuration, the cover element 24 is not visible as it is covered by the working platform 28.

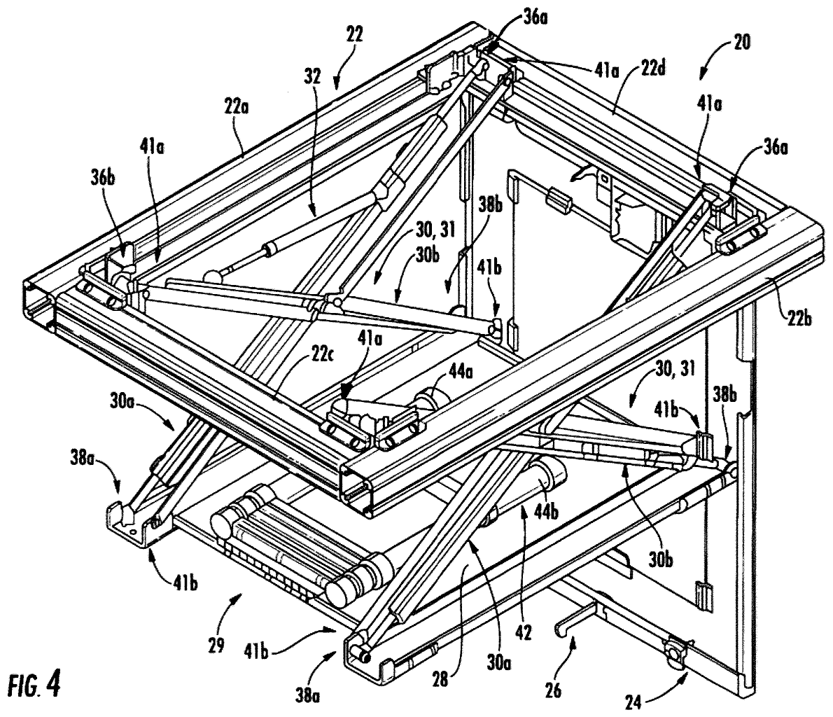

FIG. 4 shows a perspective view of the portion of the ceiling 20 shown in FIGS. 2 and 3 with the working platform 28 being arranged in an intermediate position.

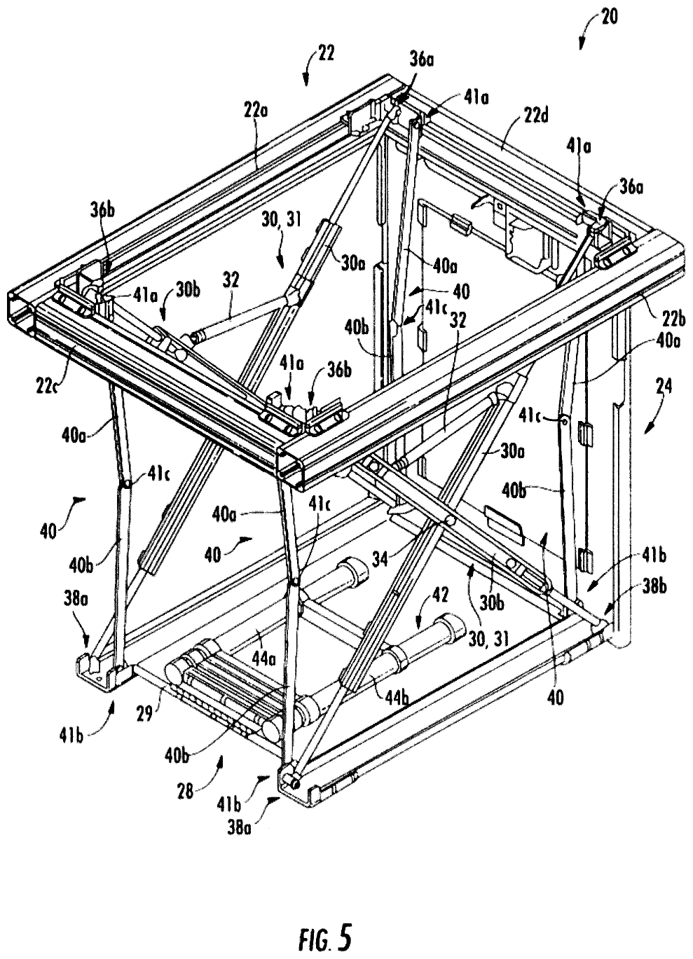

FIG. 5 shows a perspective view of the portion of the ceiling 20 shown in FIGS. 2 to 4 with the working platform 28 being arranged in the deployed working position.

Most of the features are best visible in FIGS. 4 and 5, whereas some of the features are totally or at least partly covered by other features in FIGS. 2 and 3. In order to avoid confusion, some of the features which are barely visible in FIGS. 2 and 3 are not provided with reference signs in said figures.

The portion of the ceiling 20 depicted in FIGS. 2 to 5 may extend basically over the whole top portion of the elevator car 6. Alternatively, the portion of the ceiling 20 depicted in FIGS. 2 to 5 may cover only a fraction of the top portion, and the top portion may comprise at least one additional portion, in particular a stationary portion, which is not depicted in the figures.

The portion of the ceiling 20 depicted in FIGS. 2 to 5 comprises a rectangular support frame 22 comprising four horizontally extending bars 22a-22d, two longitudinal bars 22a, 22b extending in a longitudinal direction, and two transverse bars 22c, 22d extending in a transverse direction orthogonally to the longitudinal direction.

A cover element 24, which is not visible in FIG. 2, is pivotably attached to the support frame 22. The cover element 24 basically has the same shape and dimensions as an interior opening defined by the support frame 22, so that the cover element 24 covers and closes said interior opening when the cover element 24 is arranged in a covering position, in which it is oriented horizontally parallel to the support frame 22.

The cover element 24 may support or include illumination elements (not shown) configured for illuminating the interior space 12 of the elevator car 6. Alternatively or additionally, the bottom side of the cover element 24 facing the interior space 12 ay be formed as a decorative element providing a pleasant appearance of the ceiling of the elevator car 6.

The cover element 24 may comprise a fixing element 26, such as a hook, which is configured for engaging with a complementary fixing structure (not shown) at the support frame 22 in order to fix the cover element 24 in its horizontal position as depicted in FIG. 2.

For preventing unauthorized movement of the cover element 24, the fixing element 26 may be combined with a locking mechanism (not shown). The locking mechanism may allow releasing the fixing element 26 for moving the cover element 24 out of its horizontal position only after unlocking the locking mechanism.

After the fixing element 26 has been released, the cover element 24 may be pivoted from its horizontal position, in which it extends basically parallel to the support frame 22, into a vertical access position (see FIGS. 3 to 5), in which it extends basically parallel to the side walls 17 (see FIG. 1) of the elevator car 6.

When arranged in said access position, the cover element 24 allows accessing the working platform 28, which is movably attached to the support frame 22, from the interior space 12 of the elevator car 6.

The working platform 28 is attached to the support frame 22 by at least one support structure 31. In the embodiment depicted in FIGS. 2 to 5, one support structure 31 is provided on each lateral side of the working platform 28, respectively.

Each support structure 31 comprises a scissor mechanism 30 including two scissor legs 30a, 30b extending diagonally between the working platform 28 and the support frame 22, respectively.

Each scissor leg 30a, 30b comprises a first end (upper end) pivotably connected to the support frame 22 by an upper scissor joint 36a, 36b, and a second end (lower end) pivotably connected to the working platform 28 by a lower scissor joint 38a, 38b.

A first scissor leg 30a extends between a lower scissor joint 38a mounted to a front portion of the working platform 28 shown on the left side of FIGS. 2 to 5 and an upper scissor joint 36a mounted to a rear portion of the support frame 22 shown on the right side of FIGS. 2 to 5. Correspondingly, a second scissor leg 30b extends between a lower scissor joint 38b mounted to a rear portion of the working platform 28 shown on the right side of FIGS. 2 to 5 and an upper scissor joint 36b mounted to a front portion of the support frame 22 shown on the left side of FIGS. 2 to 5.

In consequence, the first and second scissor legs 30a, 30b cross each other in central portions located between the first and second ends of the scissor legs 30a, 30b. The crossing central portions are pivotably connected with each other by central scissor joints 34. The central scissor joints 34 in particular are arranged halfway between the first and second ends of the respective scissor leg 30a, 30b, respectively.

The support structures 31 allow moving the working platform 28 vertically between the retracted storage position depicted in FIGS. 2 and 3 and the deployed working position depicted in FIG. 5. When the working platform 28 is moved, i.e. raised or lowered, the scissor legs 30a, 30b pivot at the upper and lower scissor joints 36a, 36b, 38a, 38b with respect to the support frame 22 and with respect to the working platform 28, respectively. The two scissor legs 30a, 30b of each support structure 31 also pivot with respect to each other at the central scissor joints 34.

The length of each of the scissor legs 30a, 30b is variable. This allows adjusting the lengths of the scissor legs 30a, 30b to the varying distances between the upper and lower scissor joint 38a, 38b when moving the working platform 28.

Each support structure 31 further comprises a gas spring element 32 extending between the scissor legs 30a, 30b of the respective scissor mechanism 30.

In the exemplary embodiment depicted in FIGS. 2 to 5, the gas spring elements 32 extend basically horizontally between the scissor legs 30a, 30b above the central scissor joints 34. Alternatively or additionally, gas spring elements 32 (not shown) extending basically horizontally between the scissor legs 30a, 30b below the central scissor joints 34 may be provided. Although not shown in the figures, gas spring elements 32 extending basically vertically between the scissor legs 30a, 30b on the right side and/or on the left side of the central scissor joints 34 may be provided as well.

The gas spring elements 32 are configured for damping the movement of the scissor legs 30a, 30b when the working platform 28 is lowered from its retracted storage position (FIGS. 2 and 3) into its deployed working position (FIG. 5). The gas spring elements 32 are further configured for supporting the movement of the working platform 28 when it is raised from the deployed working position into the retracted storage position.

As a result of damping the downward motion of the working platform 28, the risk of injury for a mechanic moving the working platform 28 is considerably reduced. Supporting the upward movement of the working platform 28 facilitates raising the working platform 28 from the deployed working position into its retracted storage position. In consequence, the working platform 28 may be moved safely and conveniently.

For mechanically stabilizing the working platform 28, in particular when it is arranged in the deployed working position, the elevator car 6 further comprises at least one stabilizer mechanism 40 extending between the support frame 22 and the working platform 28.

In the embodiment depicted in FIGS. 2 to 5, four stabilizer mechanisms 40 are provided. In particular, one stabilizer mechanism 40 is provided at each of the four corners of the working platform 28 having a rectangular shape.

Each stabilizer mechanism 40 comprises a first stabilizer leg 40a and a second stabilizer leg 40b. A first (upper) end of each first stabilizer leg 40a is pivotably mounted to the support frame 22 by an upper stabilizer joint 41a, and a first (lower) end of the second stabilizer leg 40b is pivotably mounted to the working platform 28 by a lower stabilizer joint 41b.

Opposing second ends of the first and second stabilizer legs 40a, 40b facing each other are pivotably connected with each other by a central stabilizer joint 41c.

When the working platform 28 is arranged in the deployed working position as depicted in FIG. 5, the stabilizer legs 40a, 40b of each stabilizer mechanism 40 extend basically coaxially along a substantially vertical direction. In consequence, the stabilizer legs 40a, 40b of the four stabilizer mechanisms 40, the working platform 28 and the support frame 22 in combination form a basically rectangular cage. This increases the mechanical stability of the working platform 28 when arranged in the deployed working position. The central stabilizer joints 41c may be lockable in said position in order to increase the rigidity of said cage even further.

When the working platform 28 is moved from the deployed working position into the retracted storage position, the two stabilizer legs 40a, 40b pivot with respect to each other, with respect to the support frame 22 and with respect to the working platform 28, respectively. As a result, the stabilizer mechanisms 40 fold similar to the scissor mechanisms 31. This folding allows space-savingly storing the stabilizer mechanisms 40 with the stabilizer legs 40a, 40b oriented basically parallel to the working platform 28 and the support frame 22, when the working platform 28 is arranged in the retracted storage position (see FIGS. 2 and 3).

In the exemplary configuration shown in FIGS. 2 to 5, a ladder 42 is provided on the upper side of the working platform 28.

The ladder 42 in particular may be a telescopic ladder 42 comprising two telescopic bars 44a, 44b. The telescopic bars 44a, 44b may be compressed in order to allow storing the ladder 42 on the working platform 28 as depicted in FIGS. 2 to 5.

When the working platform 28 is arranged in the deployed working position (FIG. 5), the ladder 42 may be pivoted around a front edge 29 of the working platform 28, and the telescopic bars 44a, 44b may be expanded in order to extend the ladder 42 for bridging the distance between the floor 16 (FIG. 1) of the elevator car 6 and the working platform 28 allowing a mechanic to easily climb onto the working platform 28.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention is not limited to the particular embodiments disclosed, but that the invention includes all embodiments falling within the scope of the claims.

### REFERENCES

2 elevator system

3 tension member

4 hoistway

5 drive

6 elevator car

7a landing control panel

7b car operation panel

8 landing

10 landing door

11 elevator car door

12 interior space

16 floor

17 sidewall

18 elevator control

19 position sensor

20 ceiling

22 support frame

22a, 22b longitudinal bars of the support frame

22c, 22d transverse bars of the support frame

24 cover element

26 fixing element

28 working platform

29 front edge of the working platform

30 scissor mechanism

30a first scissor leg

30b second scissor leg

31 support structure

32 gas spring element

34 central scissor joint

36a, 36b upper scissor joints

38a, 38b lower scissor joints

40 stabilizer mechanism

40a first stabilizer leg

40b second stabilizer leg

41a upper stabilizer joint

41b lower stabilizer joint

41c central stabilizer joint

42 ladder

44a, 44b telescopic bars

What is claimed is:

1. Elevator car (6) defining an interior space (12) for accommodating passengers and/or cargo and comprising:
a support frame (22) positioned on top of the interior space (12);
a working platform (28); and
a support structure (31) movably connecting the working platform (28) with the support frame (22);
wherein the support structure (31) comprises at least one scissor mechanism (30) including two scissor legs (30a, 30b) pivotably connected with each other; with a first end of each scissor leg (30a, 30b) pivotably connected to the support frame (22), and a second end of each scissor leg (30a, 30b) pivotably connected to the working platform (28);
wherein the support structure (31) further comprises at least one gas spring element (32) extending between the scissor legs (30a, 30b) of the at least one scissor mechanism (30).

2. Elevator car (6) according to claim 1, wherein each scissor leg (30a, 30b) is connected to a corner of the working platform (28) and/or to a corner of the support frame (22), respectively.

3. Elevator car (6) according to claim 1, wherein each scissor leg (30a, 30b) has a middle portion between its two ends, and wherein the two scissor legs (30a, 30b) of the at least one scissor mechanism (30) are pivotably connected to each other at their respective middle portions.

4. Elevator car (6) according to claim 1, wherein the length of the scissor legs (30a, 30b) is variable; wherein the scissor legs (30a, 30b) in particular are telescopic scissor legs (30a, 30b).

5. Elevator car (6) according to claim 1, wherein the at least one gas spring element (32) extends basically horizontally or vertically between the scissor legs (30a, 30b).

6. Elevator car (6) according to claim 1, wherein the support structure (31) comprises two scissor mechanisms attached to opposite sides of the working platform (28).

7. Elevator car (6) according to claim 6, wherein each of the scissor mechanisms comprises at least one gas spring element (32), respectively.

8. Elevator car (6) according to claim 1, further comprising at least one stabilizer mechanism (40) extending between the support frame (22) and the working platform (28).

9. Elevator car (6) according to claim 8, wherein the at least one stabilizer mechanism (40) comprises a first stabilizer leg (40a) and a second stabilizer leg (40b) pivotably connected with each other, wherein the first stabilizer leg (40a) is pivotably mounted to the support frame (22) and the second stabilizer leg (40b) is pivotably mounted to the working platform (28).

10. Elevator car (6) according to claim 8 comprising a plurality of stabilizer mechanisms (40), each stabilizer mechanism (40) extending between a corner of the working platform (28) and a corresponding position of the support frame (22).

11. Elevator car (6) according to claim 10, wherein a stabilizer mechanism (40) is mounted to each corner of the working platform (28).

12. Elevator car (6) according to claim 1, wherein the support structure (31) and/or the working platform (28) are lockable in at least one of their retracted and deployed positions.

13. Elevator car (6) according to claim 1, further comprising a cover element (24) pivotably attached to the support frame (22), wherein the cover element (24) is positionable between the working platform (28) and the interior space (12), when the working platform (28) is oriented in its retracted position.

14. Elevator car (6) according to claim 13, wherein the cover element (24) is lockable when arranged between the working platform (28) and the interior space (12).

15. Elevator system (2) comprising at least one elevator car (6) according to claim 1.
